(19) United States
(12) Patent Application Publication
(10) Pub. No.: US 2009/0234570 A1
(43) Pub. Date: Sep. 17, 2009

(54) METHOD AND APPARATUS FOR UNIVERSAL AND UNIFIED LOCATION REPRESENTATION AND ITS INTERACTION WITH GPS DEVICES

(76) Inventor: Gil Sever, Rosh-Haayin (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/403,899

(22) Filed: Mar. 13, 2009

Related U.S. Application Data
(60) Provisional application No. 61/036,270, filed on Mar. 13, 2008.

(51) Int. Cl. G01C 21/00; G06F 17/30

(52) U.S. Cl. 701/200; 707/104.1; 707/E17.018

(57) ABSTRACT

Location information is translated from a variety of formats to a common uniform format and then fed into a GPS device in an easy and automatic manner. A global canonical and unique numeric representation of a specific location is created. This involves a global bi-directional translation method between an address, which may reside or presently exist in one of many possible formats, into a uniform standardized canonical representation of location. The uniform location representation can be read by, and later transferred into, a GPS device. Advantageously, this eases the process of finding desired destinations in various ways, and the ease of storing location data regarding those destinations.

### CROSS-REFERENCE TO RELATED APPLICATIONS

This application is a U.S. Non-Provisional application for Patent filed under 37 USC. 1.53(b) and claiming the benefit of the priority of U.S. Provisional Application for Patent filed on Mar. 13, 2008 and assigned Ser. No. 61/036,270, which application is hereby incorporated by reference.

### BACKGROUND

GPS usage for navigational purposes is now extremely wide-spread, and the technology is considered quite useful. GPS devices have become a popular accessory in many vehicles, and many car companies now market their new car models with built-in navigation systems.

Despite the obvious advantages of GPS technology, the technology is plagued with major shortcomings. One such shortcoming is that anyone that wishes to feed a GPS based device with a new target location, (e.g. a driver that wants driving directions to a certain new destination), must manually feed data into the GPS device. This shortcoming is intensified when one has to feed location data while driving. Thus, there is a need in the art for a technique to improve the way that target locations are provided to a GPS device.

Another shortcoming of GPS technologies is accurate identification of locations is not always available. Some places, businesses, establishments, locations, etc. don't have a unique description of their location. For example, a building that is situated at the corner between two streets and may have two different valid addresses. Further, locations that are in rural areas may not have granular location information associated with the location other than a route number. Another shortcoming with GPS technology is that the address structure may be different in different countries or even areas within the same country. For instance, some addresses will be written in a particular order: state, city, street, number of house/building, but others will be written as township, state, county, and neighborhood and so on. At times, the same address can be inserted in several ways, such as 1st Street or First Street. Addresses in foreign countries often exist only in the local language, without a translation to English. Thus, there is a need in the art for a technique to more accurately identify address or target location description information and to have the ability to recognize such information in a variety of formats.

Another shortcoming with GPS technology related to location representation is that most addresses only refer to two-dimensional addresses, with regards to latitudes and longitudes and not to the third dimension—the vertical dimension. If a person has to find a specific company within a 100-story tall building, the street address is just the beginning.

An addition to this problem is the fact that standard addresses cannot represent the location of a company within the specific floor of an office building, and even further, the location of a specific department within that company.

Another problem with GPS technology is evident when looking at large areas that are in a closed compound, and different entities inside those compounds. In some of these cases, to drive to a specific entity, one must gain entrance into the compound first, and only from there can the subject continue to the specific entity. Thus, there is a need in the art for an improved granularity on location information within a building, structure or compound.

Therefore, these and many other needs are present in the art for improved operation of GPS technology to overcome these, as well as many other shortcomings.

### BRIEF SUMMARY

The present disclosure presents solutions to these, as well as other needs in the art by disclosing systems and methods for translating location information from a variety of formats to a common uniform format and feeding the location information into a GPS device in an easy and automatic manner. Further, the present disclosure presents a simple method to define a global canonical and unique numeric representation of a specific location. This method is applicable world-wide, and easily recognizable by all GPS devices and GPS users.

More particularly, one aspect, feature or operation presented in this disclosure relates to a global bi-directional translation method between an address, which may reside or presently exist in one of many possible formats, into a uniform standardized canonical representation of location. The uniform location representation can be read by, and later transferred into, a GPS device. More particularly the present disclosure relates to improving the ease of finding desired destinations in various ways, and the ease of storing location data regarding those destinations, so that such data might be used at a later time in the future.

A second aspect, feature or operation presented in this disclosure relates to methods of using the standard canonical representation and feeding it as easily and as automatically as possible to or from a GPS device. More particular, embodiments may provide such an operation by using the assistance of methods and devices such as, but not limited to, a cellular telephone, a barcode reader, a USB thumb drive, an RFID tag, an optical scanner with added OCR capabilities, etc. Such methods or devices might be used to easily display the canonical representation on business cards, newspaper adds etc.

One possible way to define a unique location representation is to use a UTM 12 digit representation. UTM 12 is a simple method to determine and translate that uniform representation to each location on earth.

Also disclosed is a method to make the canonical representation accessible to end-users, so that they can find it in an easy and simple way and feed it into GPS devices manually or automatically. One embodiment of the method includes creating a canonical representation for a physical location, the canonical representation operating as a uniform identifier for a variety of descriptive location forms. Initially, location descriptive information or descriptors for a particular location are received from an input device. A processing unit then parses the location descriptive information to identify address characteristics (such as street names, cities, states, countries, Zip codes, etc. The information is then normalized by the processing unit by mapping the identified characteristics to common synonyms. For example, street, ST., strt etc. could be mapped to St; Road, road, rd, etc. could be mapped to Rd, etc.). The normalized location descriptive information is then converted by a processing unit into the canonical representation.

Another option is to display that canonical representation not in its original numeric form, but by one or more of the hereby mentioned ways: barcode, digital format and/or RFID tag.

A simple method for reading that form of representation when it is published, such as on adds, business cards, in business directories etc.) includes using one or more of the following devices: a barcode reader, a text reader, a digital camera in a mobile telephone that uses OCR (optical character reading) technology to transfer the location representation to its numeric form and transfer it to the GPS device via an SMS (short messaging service), an optical scanner with added OCR capabilities, a barcode translator, an RFID reader, etc.

A simple way to write the uniform representation found to the actual memory of the GPS device includes using one of the following: an IR transmitter, WiFi, Bluetooth, detachable storage device (such as a USB flash drive, an SD card, etc.), Zigbee, WiMAX, Cellular, or any other wired or wireless communication technique.

Various embodiments may also include one or more of the following features.

Three dimensional locations. Embodiments may include the feature of adding an additional numeric field to a canonical location representation, so that it may relay not only the longitude and latitude of a certain location but also parameters of height and orientation within that location or a specific location inside a large compound. One example for using this option is when a GPS user needs to arrive at a meeting in a specific firm or company within a building that has dozens of floors. The additional field will help the user to find the correct floor and within that floor, the specific company he or she is looking for.

Image assisted guidance. Embodiments may include the feature of using images to guide passengers to specific locations and help them verify that they are in the right location. Such a GPS device is able to download images before the passenger reaches the location in which a visual aid is needed, and display them, along with voice guidance that is compliant with the image—instead of “take the right lane in 500 meters”, “take the right lane after you pass this house (displayed in the image) on your right”.

Supplemental location information. Embodiment may include the feature of reading the uniform representation off a physical location the user is currently in, by intercepting a signal from an RFID transmitter that is located on a specific site and using it to refine the user's location reading from the GPS (in cases where there are GPS reception problems for example), or for inserting the location of a desirable site into the GPS memory for future use.

### BRIEF DESCRIPTION OF THE SEVERAL VIEWS OF THE DRAWING

FIG. 1 illustrates a conversion between two formats of representation.

FIG. 2 illustrates a business card with uniform canonical location representation.

FIG. 3 illustrates a newspaper ad with uniform canonical location representation.

FIG. 4 illustrates the representation of different floors and companies within a single building.

FIG. 5 illustrates the use of an RFID tag placed on the roof of an office building.

FIG. 6 is a flow diagram illustrating one embodiment of a process for converting received addresses into a common canonical representation.

FIG. 7 is a system diagram illustrating an environment in which various aspects, features and elements of the afore-described embodiments may be implemented.

### DETAILED DESCRIPTION OF VARIOUS EMBODIMENTS

The present disclosure is directed towards a universal location system and method that interacts with GPS equipment and solves various needs or shortcomings in the art. Various embodiments of the universal location system operate to allocate a canonical unique numeric representation to each and every global location. Once allocated, the representation will be made available to world-wide GPS users (or to limited subsets if so desired) and also to the owners or residents of the various locations.

The canonical representation can then be used as a convenient and common method of relaying information regarding location. Instead of having to keyg in a multi-level address structure, this feature enables the user to gain access to or pull up the address by simply entering a string of digits.

To further facilitate the usefulness of the canonical representation, the canonical representation of the location can be translated into a different form then its original numeric one. For example, one of the following formats could be used to represent the canonical representation: a barcode, digital format an RFID tag, etc.

Some embodiments may also include the use of a reader/writer device for reading the location representation and writing it to the GPS memory card. For example, the reader/writer can be combined with the GPS device itself.

The combined device can be implemented in many ways. A few non-limiting examples of the combined device include: a GPS device combined with a barcode reader, a text reader, a digital camera in a mobile telephone that uses OCR technology to transfer the location representation to its numeric form and transfer it to the GPS via SMS, an optical scanner with added OCR capabilities, a barcode translator, an RFID reader, etc.

The combined device may include a simple way to write the canonical representation to the actual memory of the GPS device, using, as a non-limiting example, one of the following technologies: an IR transmitter, WiFi, Bluetooth, detachable storage device (such as a USB flash drive, an SD card, etc.), Zigbee, WiMAX, Cellular, or any other wired or wireless communication technique.

The combined device will enable GPS users to insert data into their GPS memory easily, preventing the need to feed location information manually. A user might just open a newspaper, see an advertisement of a shop he or she would like to visit, read the uniform representation off the paper using the combined device and be on his or her way.

Another example of a common use for the combined device is reading the uniform representation off of a business card and inserting it into the GPS device for future reference.

Yet another example for the use of the combined device is for reading the address off of a physical location the user is currently in or at, and inserting the read address into the GPS device for future reference. This option, which may rely on representation in RFID tag format, can enable businesses to make sure potential customers and even a passers-by have their location stored within their GPS devices.

Some embodiments may include one or more advanced options. Non-limiting examples of such advanced options can include:

Addition of vertical dimension. This feature or option includes adding an additional numeric field to the canonical representation so that the representation incorporates information regarding the height or vertical position of the desired location rather than only its longitude and latitude. The additional digits might represent a floor in an office building. Another use for this addition is to specify a particular location within a location, meaning, pointing out a single company or office in a maze of companies that might rent offices on the same floor or building. This advanced option can dramatically improve the orientation within buildings and other commercial properties.

Image Guidance. This option or feature includes creating an image database that can be used to assist or help guide the GPS users to the desired location using not only verbal instructions but also images of their surroundings. The combined device can download the relevant images before the user reaches the applicable location for which the images depict landmarks, etc, and can then display those images as a means of further simplifying the instructions given by the GPS device. The images may enable the user to verify that he or she is indeed following the instruction correctly.

Alternatively, instead of images, the GPS device can download and display verbal directives which are very specific (e.g. “after the brown building on the right turn left”), or a combination of images and verbal direction.

Overall, such embodiments can improve the ease of displaying location information and the ease of finding that location, no matter how the street address is written, what language it's written in etc., by simply converting that address into a canonical unique representation that is widely known and published. The various embodiments may also improve the ease of reading and storing location information in GPS devices. Furthermore, various embodiments may enable better orientation within buildings, making the height and the relative location within a floor or within a compound an additional variant that enhances the accuracy of the canonical representation. Various embodiments may also enable the display of images as a guidance aid for GPS users, making it much easier and simpler for users to make sure they are in the right place or choosing the right way out of a few possible options.

Turning now to the figures, various embodiments that incorporate various features and aspects described herein are presented in more detail. The purpose of the drawings is to describe one or more exemplary embodiments and not for production. Therefore features shown in the figures are chosen for convenience and clarity of presentation only.

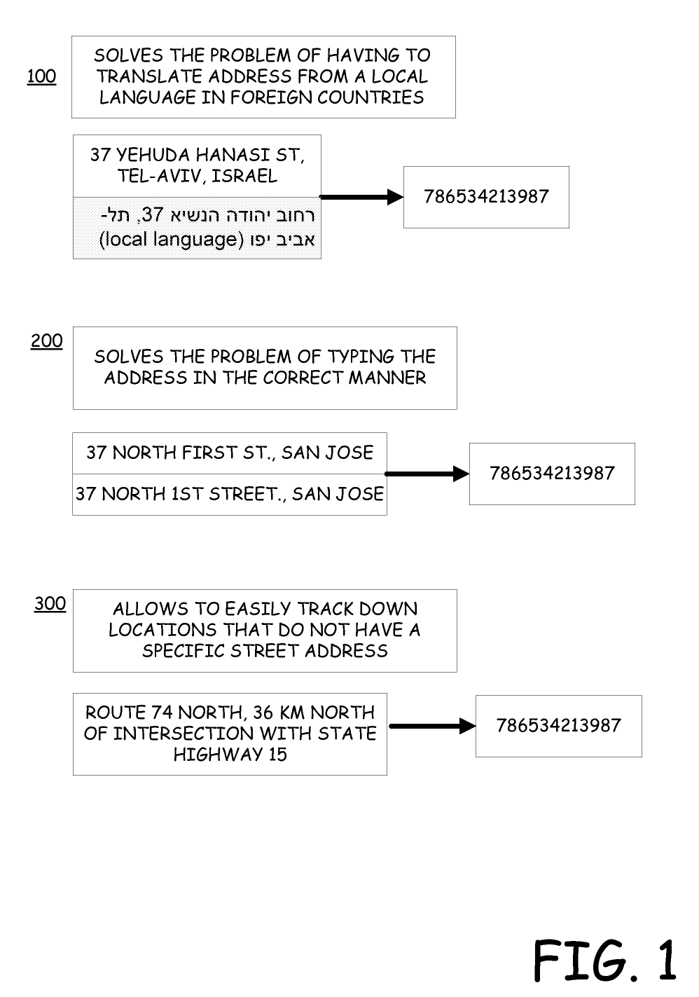

FIG. 1 is a conceptual flow diagram that illustrates the operations of various address conversions to generate canonical representations. In general, an inaccurate address or and address that may be presented in a variety of manners is converted into a canonical representation. For example, flow block 100 illustrates how the conversion of the same address, which is presented or received in two different languages, results in the same canonical representation. As another example, flow block 200 shows how the conversion of the same address, written in two different formats or styles result in the same canonical representation. Yet another example is presented in flow block 300 which illustrates the advantages of a canonical representation when the address isn't accurate or when there isn't an address at all but rather only a description of the location.

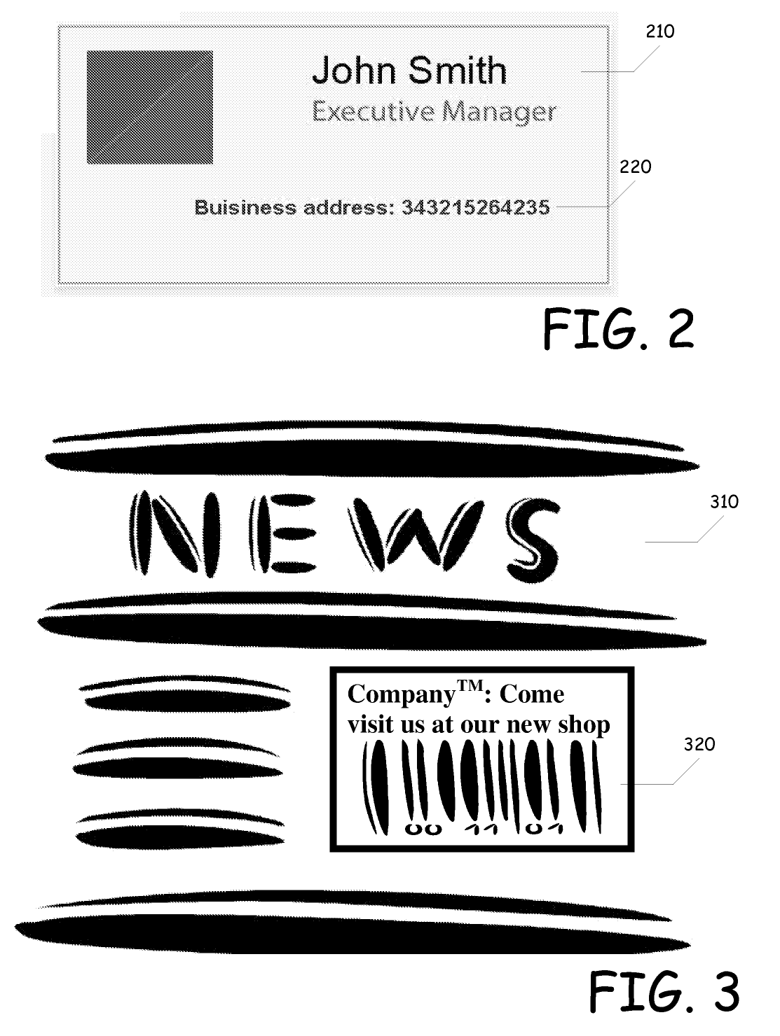

FIG. 2 is an illustrative application of the canonical representation. In the illustrated application, the canonical representation is presented on a business card 210 that has the canonical location representation 220 written on it instead of a standard street address. Thus, the business man that gives away the card can make sure that people have an easy and reliable method of reaching his place of business. It should be appreciated that advantageously, the use of the canonical representation also uses less space and as such allows the business cards to convey more information. It should also be appreciated that a web-based application, a telephone interactive system or any of a variety of other systems may be used to receive a canonical representation an convert it into a textual or audible recitation of the actual address. For example, an individual trying to find the address without a GPS system may call a specific number, enter the canonical representation and receive and audible representation of the address, a text message containing the address, an email, etc.

FIG. 3 is another illustrative application of the canonical representation. In the illustrated application, the canonical representation of a location of a business, or other address is presented in a newspaper add 310 in the form of a barcode 320. The barcode information can be easily transferred into a GPS device that includes a barcode reader. Thus, the canonical representation (i.e. a 12 digit code) can be displayed in the form of a bar code that can be scanned by the barcode reader.

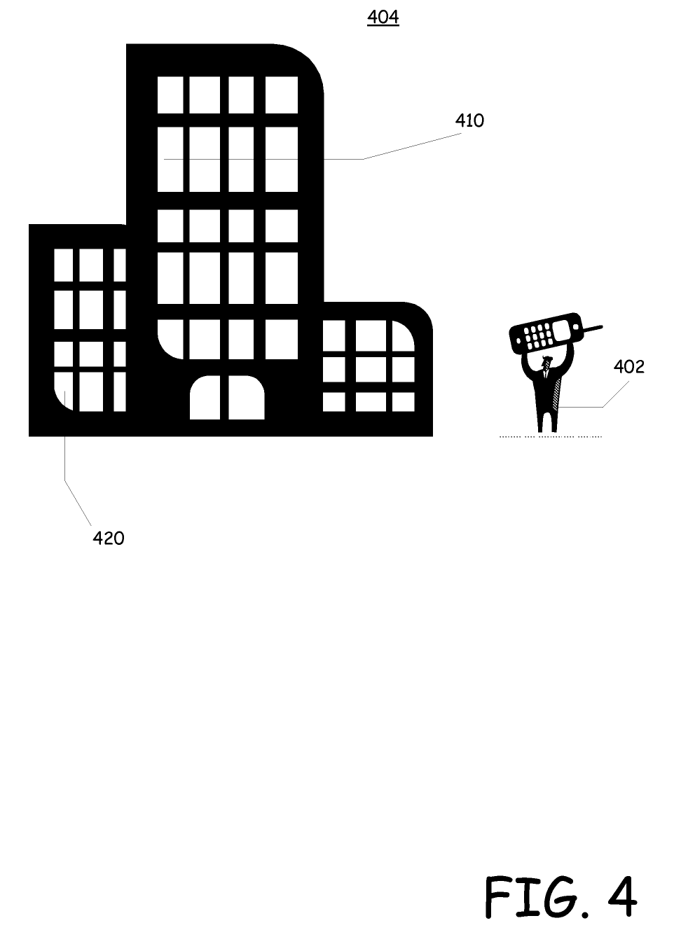

FIG. 4 illustrates an environment in which a third dimension in location information can be beneficial to assist parties in finding their destination. The illustrated environment is a multi-storied and multi-sectional office building. Without the employment of the third or additional location element for various embodiments, a searching party can only be navigated to the building. At that point the searching party is left to his own to find the particular location. Various embodiments can include the third or addition location element to enable orientation within an office building, or any other location where the street address only describes the entrance and there is further need for guidance within that location. In the illustrated example, within an office building or complex 404, each floor or company may have a specific representation in the form of one or more digits or characters. These one or more digits or characters are added to the other location representation information which describes only the main address. With this additional information, the searching party 402 can navigate right to the particular section and/or floor of the building or building complex (such as in a hospital or school). For example, to get to office 410, the searching party 402 may received a canonical representation that identifies the building, and then the 5^{th} floor of the main building. Similarly, to get to a small office 420 on the first floor of the left wing, the canonical representation may identify the same building and then the third element identifies the wing and floor and office.

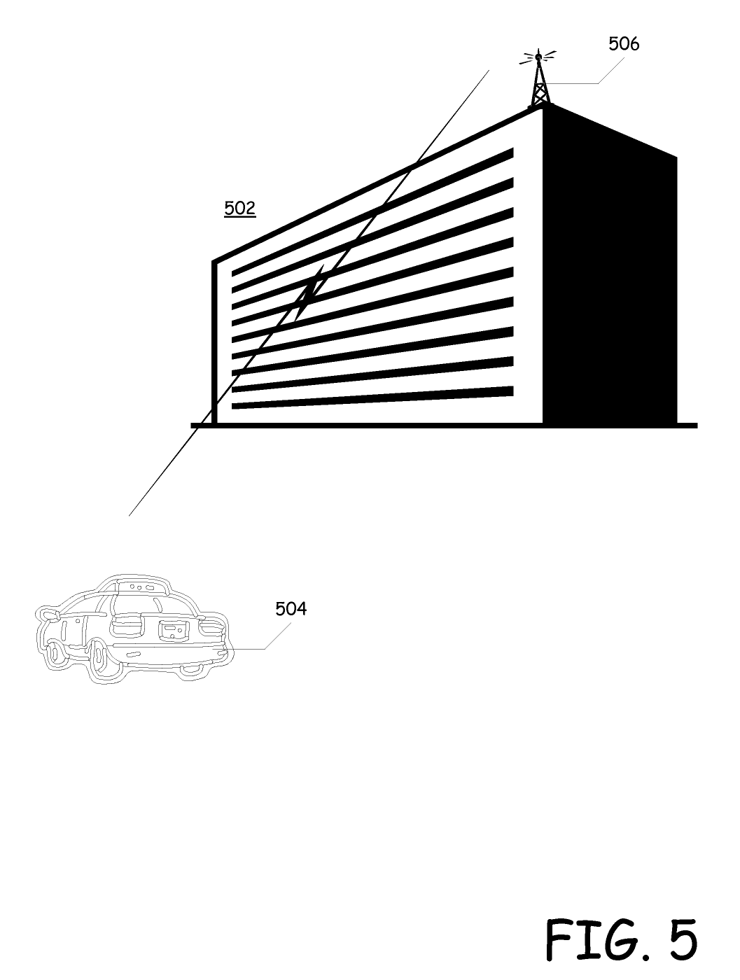

FIG. 5 is a conceptual diagram illustrating the application of another embodiment that employs RFID's or other transmitters to identify a location. In the illustrated embodiment, a car or party 504 is in the proximity of a building 502. The building 502 includes a transmitter 506 that transmits location information about the building. For example, the transmitter may be an RFID tag, a low power transmitter, etc. In operation, the transmitter periodically or a periodically transmits the canonical representation of that location. The transmitted signal can be detected by various devices that either drive by, carried by pedestrians going by, etc. by a GPS device combined with a receiver that matches up with the transmitter, such as an RFID reader. Once an address is received by the GPS device, the user can decide whether or not to keep the location. For instance, if the user does nothing, the received canonical representation may automatically be processed. Depending on the embodiment the process may include storing or deleting the representation. In addition, the user may take proactive action to either save or delete the representation.

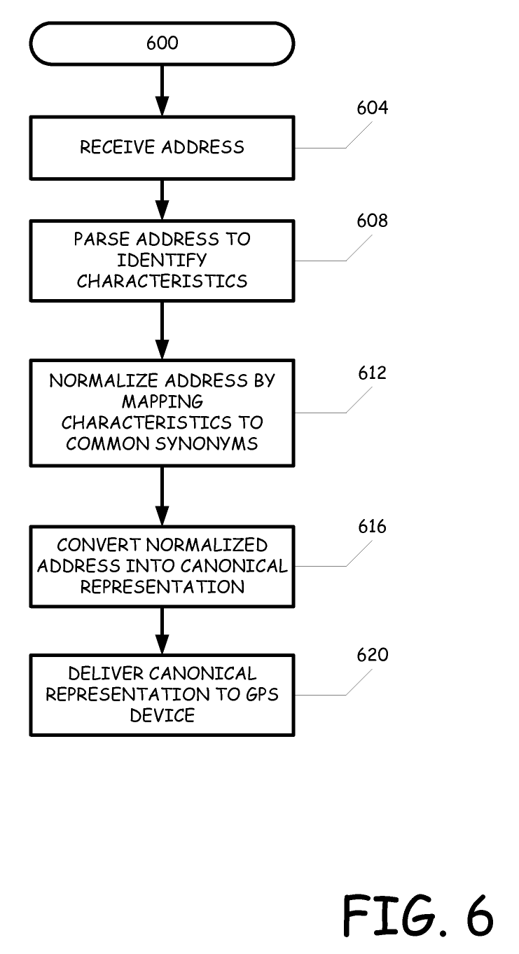

FIG. 6 is a flow diagram illustrating one embodiment of a process for converting received addresses into a common canonical representation. The process 600 is only an example of one of many techniques that can be used to generate a canonical representation of an address. In general, the canonical representation provides a common, normalized technique to correspond to various alternate representations of an address. As such, the relationship between various representations of an address and the canonical representation is typically a many to one mapping. The exact algorithm used to generate the canonical representation, and the format of the canonical representation is not a limiting factor in the various embodiments but rather, a variety of techniques such as hashing algorithms, mapping codes, error-correcting codes, BCH codes, hamming codes, etc. can be used to generate the canonical representations. Those skilled in the art will be familiar with variety of techniques that can be used to take a larger amount of information, such as an address and reduce the representation of the content to a particular code that can be more efficiently stored and/or communicated. Techniques can also be employed for providing error correction and collision resolution for such techniques to ensure that a unique mapping is available for each particular location. Various such techniques can be found in the book “An Introduction to Error-Correcting Codes” by Shu Lin, Prentice-Hall, Inc 1970 The illustrated process 600 begins by receiving an address 604. The address can be in a variety of formats as illustrated in FIG. 1 and can be received from a variety of sources. For example, the address may be keyed in by a user, scanned in, received via various forms of transmission, IR, etc.

Once the address is received, the address is parsed 608 in an effort to determine the format of the address and identify the various address attributes or characteristics. For example, two letter words can be compared against a database of two letter codes for states, other word combinations can be cross-referenced to a database of city names, etc. Combinations of number and letters can also be compared against a database of synonyms in an effort to determine what they represent. For instance, the following entries are synonyms and can be mapped to a common normalized representation: “1^{st}” “First” “1 ST”. The algorithm must also take into consideration issues such as whether the ST in “1 ST” should be mapped to shorthand for first or street. Thus, the algorithm must not only look at the characters but also the context of the address. It should be appreciated that similar algorithmic procedures could be implemented for converting audible address from speech into normalized text. As such, the various address attributes, components and characteristics are mapped to common synonyms 612 to normalize the address. Once the address is normalized, it is then converted into a canonical representation 616 which, as previously mentioned, can be performed using a variety of techniques. The canonical representation may also be embodied in a variety of formats, such as the previously mentioned 12-digit code and barcodes, as well as any of a variety of other formats including electronic signals, etc.

The canonical representation of the address may then be delivered to the GPS device using one or more of a variety of the techniques previously described as well as other techniques.

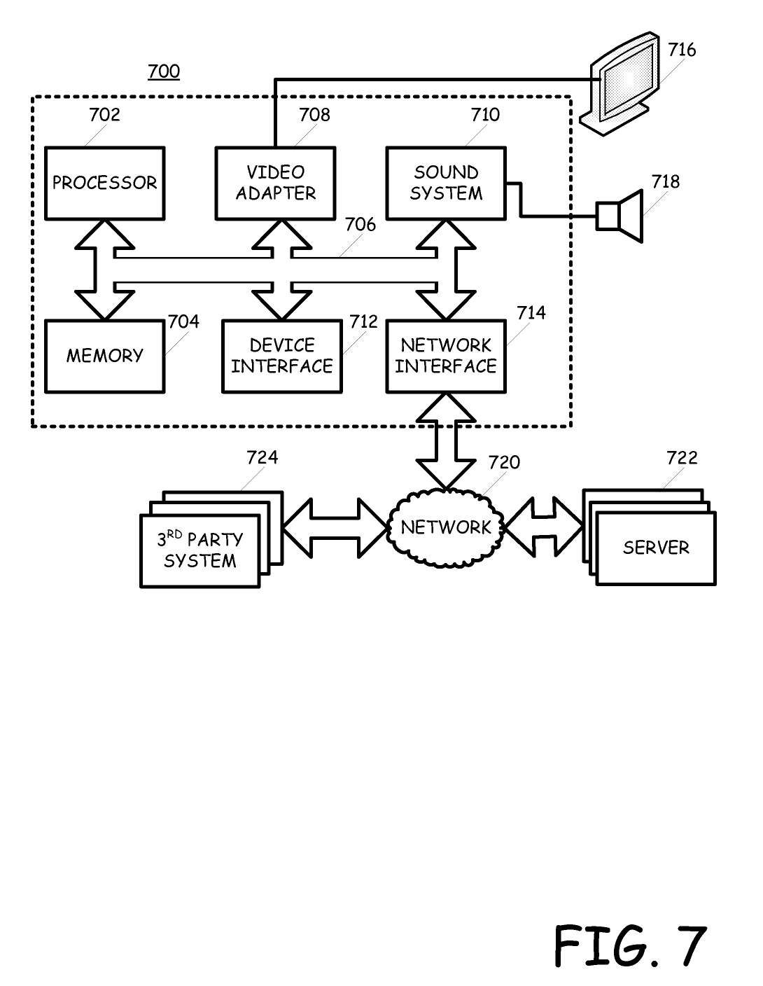

FIG. 7 is a system diagram illustrating an environment in which various aspects, features and elements of the afore-described embodiments may be implemented. A general computing platform 700 is shown as including a processor 702 that interfaces with a memory device 704 over a bus or similar interface 706. The processor 702 can be a variety of processor types including microprocessors, micro-controllers, programmable arrays, custom IC's etc. and may also include single or multiple processors with or without accelerators or the like. The memory element 704 may include a variety of structures, including but not limited to RAM, ROM, magnetic media, optical media, bubble memory, FLASH memory, EPROM, EEPROM, etc. The processor 702 also interfaces to a variety of elements including a video adapter 708, sound system 710, device interface 712 and network interface 714. The video adapter 708 is used to drive a display, monitor or dumb terminal 716. The sound system 710 interfaces to and drives a speaker or speaker system 718. The device interface 712 may interface to a variety of devices (not shown) such as a keyboard, a mouse, a pin pad, and audio activate device, a PS3 or other game controller, bar code reader, as well as a variety of the many other available input and output devices. The network interface 714 is used to interface the computing platform 700 to other devices through a network 720. The network may be a local network, a wide area network, a global network such as the Internet, or any of a variety of other configurations including hybrids, etc. The network interface may be a wired interface or a wireless interface. The computing platform 700 is shown as interfacing to a server 722 and a third party system 724 through the network 720.

In the description and claims of the present application, each of the verbs, “comprise” “include” and “have”, and conjugates thereof, are used to indicate that the object or objects of the verb are not necessarily a complete listing of members, components, elements, or parts of the subject or subjects of the verb. Also the phrase “numeric” can be replaced by “alpha numeric”.

The present invention has been described using detailed descriptions of embodiment thereof that is provided by way of example and is not intended to limit the scope of the invention. The described embodiment comprises different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for creating a canonical representation for a physical location, the canonical representation operating as a uniform identifier for a variety of descriptive location forms, the method comprising the steps of:
receiving location descriptive information for a particular location from an input device;
parsing the location descriptive information by a processing unit to identify address characteristics;
normalizing the location descriptive information by a processing unit mapping the identified characteristics to common synonyms; and
converting the normalized location descriptive information by a processing unit into the canonical representation.

2. The method of claim 1, further comprising the step of embodying the canonical representation into a form that can be used to control a navigation device.

3. The method of claim 1, further comprising the step of delivering the canonical representation to a navigation device for controlling the operation of the navigation device.

4. The method of claim 1, further comprising the step of printing the canonical representation onto a bar code.

5. The method of claim 1, further comprising the step of storing the canonical representation into an RFID tag.

6. The method of claim 1, further comprising the step of storing the canonical representation into a digital memory device.

7. The method of claim 1, further comprising the steps of:
entering the canonical representation to a navigation device;
translating the canonical representation by the navigation device into a physical location; and
using the physical location at input to a navigational operation provided by the navigational device.

8. The method of claim 1, further comprising the step of storing a plurality of canonical representations, with each corresponding to a physical location, into a database that can be accessed over a network.

9. The method of claim 1, further comprising the steps of:
embodying the canonical representation into a tangible medium;
reading the canonical representation from the tangible medium by a processing device; and
transferring the canonical representation to a navigation device to control the operation of the navigation device.

10. The method of claim 9, wherein the step of embodying the canonical representation into a tangible medium further comprises creating a barcode and, the step of reading the canonical representation by a processing device further comprises taking a digital image of the barcode with a digital camera in a mobile telephone and converting the digital image into the canonical representation.

11. The method of claim 9, wherein the step of embodying the canonical representation into a tangible medium further comprises creating a textual representation and, the step of reading the canonical representation by a processing device further comprises taking a digital image of the textual representation with a digital camera in a mobile telephone and converting the digital image into the canonical representation.

12. The method of claim 9, wherein the step of transferring the canonical representation to the navigation device further comprises transmitting signals over a wireless communication channel.

13. The method of claim 9, wherein the step of transferring the canonical representation to the navigation device further comprises sending a text message to the navigation device.
and allocating that representation to each and every location world wide.

14. The method of claim 1, further comprising the step of associating the canonical representation with a plurality of representations for the particular location.

15. A navigational apparatus comprising:
an input device for receiving a canonical representation for a physical location created using the method of claim 1; and
a display for displaying a graphical depiction of the physical location and a current location;

16. The navigation apparatus of claim 15, wherein the input device is a wireless receiver.

17. The navigational apparatus of claim 15, wherein the input device is a digital cameral.

18. The navigational apparatus of claim 15, wherein the input device is a barcode reader

19. The navigational apparatus of claim 15, wherein the input device is a keyboard.

20. A method for creating a canonical representation for a physical location, the canonical representation operating as a uniform identifier for a variety of descriptive location forms, the method comprising the steps of:
receiving a plurality of location descriptors from an input device, each being associated with a particular location;
parsing each of the location descriptors by a processing unit to identify address characteristics;
normalizing the location descriptors by a processing unit mapping the identified characteristics to common synonyms;
identifying physical locations associated with the normalized location descriptors;
converting the normalized location descriptor by a processing unit into canonical representations;
associating the canonical representations with the physical location; and
storing the canonical representation and the association into a database.
